(19) United States
(12) Patent Application Publication
(10) Pub. No.: US 2009/0018909 A1
(43) Pub. Date: Jan. 15, 2009

(54) Optional progressive price reduction system using sponsorship subsidization.

(76) Inventor: William Grecia, Brooklyn, NY (US)

Correspondence Address: William Grecia, 932 East 79th Street, Brooklyn, NY, 11236, US

(21) Appl. No.: 11/778,046

(22) Filed: Jul. 15, 2007

(51) Int. Cl. G06Q 30/00

(52) U.S. Cl. 705/14

(57) ABSTRACT

An optional progressive price reduction system using sponsorship subsidization which allows content owners to provide multiple purchasing options for consumers. The purchasing options provided by this system offers an incentive for consumers to obtain expensive internet based content delivered through a facilitator. At the point of sale of a product, consumers can choose a payment option comprising a prepaid sponsorship model which reduces the retail price according to the consumer's preference or pay the full retail price for consumers who wish to avoid advertising.

### PATENT REFERENCES

May 21, 2001 Jones

Nov. 17, 1998 Neel

Aug. 11, 1998 Goldhaber

### FOREIGN PATENT REFERENCES

EP May, 1999 Neilsen

### OTHER REFERENCES

The definition of the words “subsidy” and “royalty”—internet link: http://www.merriam-webster.com/dictionary/subsidy

### FIELD OF THE INVENTION

With the growing consumer trend of obtaining multimedia content through the internet, content owners are losing profits of copyrights from illegal file sharing tactics exercised by consumers. Sponsorship methods such as advertising has become the premiere source of revenue for internet entertainment but due to the diverse spectrum of digital content pricing, the current model for subsidy is only true for products with very low pricing in which a consumer view a sponsor message and then receive a low cost item such as a $0.99 MP3 file. The prior art for sponsored content distribution do not work for expensive items such as burnable retail CD and DVD products with a price range of $10 to $30. With this document, the inventor teaches a new method for price subsidization using multimedia powered internet based sponsorship. This document further teaches how to offer expensive valued content to consumers by adding an extra purchasing option durring the point of sale which allows payment at the full retail price or at a reduced price subsidized by sponsorship.

### BACKGROUND OF THE INVENTION

The prior art referenced to this invention only teach a stern method of receiving free content and incentives for viewing advertising content. Such method limits consumers' ability to avoid further advertising during the middle of a presentation and offer the option to pay a reduced price. Many consumers have the tendency to dislike extensive advertising campaigns in relation to a single source of desirable content and will ignore and avoid interaction. Prior art contained in U.S. Pat. No. 5,838,314 (Neel) discloses an interactive video services system that offers a viewer the incentive of a free movie provided the viewer agrees to view an interactive advertisement. The prior art of this invention neither alone nor in combination with other prior art teach and suggest a method of progressive price reduction which provides the customer an option to pay a reduced price for the content of interest. Neel teaches a simple 2 step process comprised of watching an advertisement to receive a free product. This method will not work with expensive product consumption by impatient consumers not willing to view the vast amount of advertising needed to pay for the full retail cost of the product. Prior art contained in U.S. Pat. No. 5,794,210 (Goldhaber) discloses “orthogonal sponsorship” programs by which direct financial incentives (e.g. “CyberCoin”) are provided to consumers who elect to view certain advertisements that are presented to them by “attention brokers”. Specifically, a consumer is presented with a list of advertisements each of which may be selected by a consumer to view in exchange for receiving direct cash deposit into the consumer's pre-established account. Goldhaber does not contain any disclosure or suggestion of distributing media products and does not teach or suggest products of any kind. This invention teaches of a subsidized method of consumer benefits which do not award tangible money awarded to the consumers' financial banking account. According to Merriam-Webster's online dictionary, the term “subsidized” and the simpler term “subsidy” defines: to purchase the assistance of by payment of a subsidy and to aid or promote (as a private enterprise) with public money. This invention teaches the use of a facilitator to host in escrow revenue paid by advertisers which is distributed as public money to content owners after a successful prepaid sponsor message impression. U.S. patent application Ser. No. 09867181 (Jones) teaches the use of a facilitator to display of a sponsor message to a consumer before granting access to the content of interest but do not teach the method of providing a reduced product price subsidized from the advertising revenue. Jones further teaches the method of paying for royalties to content owners by using advertising revenue, but do not teach the method of paying a full retail price of a product by using advertising revenue. According to Merriam-Webster's online dictionary, the term “royalty” defines: a payment to an author or composer for each copy of a work sold or to an inventor for each item sold under a patent. Jones' document does not teach how a system can subsidize expensive retail prices of digital content such as burnable CD and DVD products using advertising to reduce the product price to a preferred amount at which time the consumer can pay the reduced price. Jones only teach the method of royalty payment which can not allow content owners to benefit from U.S. patent application Ser. No. 09867181 because the simple adverting method explained do not provide a clear way to deliver full priced retail products. Prior art contained in European Patent 0913789 (Neilsen) discloses sponsors of websites may want to provide users with hyperlinks to other online content, some of which may require a payment to view or download. Neilsen discloses enabling a site visitor to access the payment required content for free. Neilsen, however, neither alone nor in combination with supporting prior art teach and suggest a method of progressive price reduction using multiple pre-paid sponsor messages giving customers an option to pay a reduced price for the content, but teaches only of a direct method to obtain free content.

### SUMMARY OF INVENTION

With internet distributed consumer content on the rise, content owners constantly compete with illegal file sharing tactics by consumers and lose profits. Consumers claim file sharing allows an easy and inexpensive way to obtain content even though the quality of the content received is not as good of quality compared to the retail counterpart. This invention teaches of a method to allow content owners to offer retail caliber digital content through the internet directly to consumers using a system of price reduction afforded by sponsorship subsidization.

### DETAILED DESCRIPTION

The system of optional progressive price reduction using sponsorship subsidization is structured to give consumers at least two purchasing options at the point of sale of a product. The first option is to pay immediately at a full retail price and the second option is to activate a progressive sponsored messaging mechanism designed to reduce the retail price of the product gradually in continuation until the consumer decides to stop the process. The messaging mechanism referenced in this document includes but not limited to common advertising and non profit sponsorship campaigns. This system is comprised of four key participants who are: the consumer; the content owner; the sponsor; and the facilitator. The consumer's role is to make decisions to purchase products, and then at the point of sale, decide to pay the full retail price or subsidize the retail price by viewing sponsor messages. The content owner's role in this system is to provide products for consumer consumption. The content owner works through a facilitator which is responsible for the administration and management of communications between the consumer, the content owner and the sponsor. The facilitator imports money for escrow from the sponsor and pays the content owner according to a database credit system for successful message impressions. The facilitator can also serve a double role as the content owner or the advertiser providing the tools needed to successfully execute the process of this system with consumers. The sponsor provides multimedia content for viewing by the consumer for a subsidy credit to be applied to the product's price after each successful impression. The multimedia content provided by the sponsor can be comprised of text messages, static pictures, video, audio, flash files, and printable material. The facilitator provides a holding area for the advertiser's financial and multimedia resources in locations such as a bank and an online internet server. The facilitator provides a multimedia capable graphical user interface (GUI) for consumers to buy products offered from content owners under the facilitator's representation. The GUI can be an online unit connected to the internet or an offline unit with sponsor messages pre-installed on a hard drive or system memory. The consumer selects a product to purchase and at the point of sale, is presented with the GUI provided by the facilitator. The GUI presents the consumer with two purchasing options: 1) the full retail price, and 2) an option to view sponsor advertised messages. If the consumer desires to skip advertising, then they can pay the full retail price of the product and receive the product after payment through the GUI. If the consumer desires to view advertising, then the GUI presents the consumer with an embedded or external interface to fulfill the request. The consumer is required to watch an ad in its entirety and at the end of the play action; the consumer has the option to: A) accept the subsidy credit and continue watching more ads, or B) accept the subsidy credit and purchase the product at the current reduced price. In the event the consumer selects options “A” or “B”, the facilitator records the successful ad impression to the database and credits the financial resources held in escrow from the sponsor to the content owner. The consumer can continue the process of watching ads until the full retail price of the product is subsidize requiring no additional payment to finalize the process and receive the content in interest. The advertisements provided by the sponsor to the facilitator contain a prepaid value per impression to be deducted from the money balance held in escrow in the sponsor's account which is then dispersed to content owners by the facilitator. The value per advertising impression can be split according to a percentage between the facilitator and the content owner per each message successfully viewed as a commission.

### BRIEF DESCRIPTION OF THE DRAWINGS

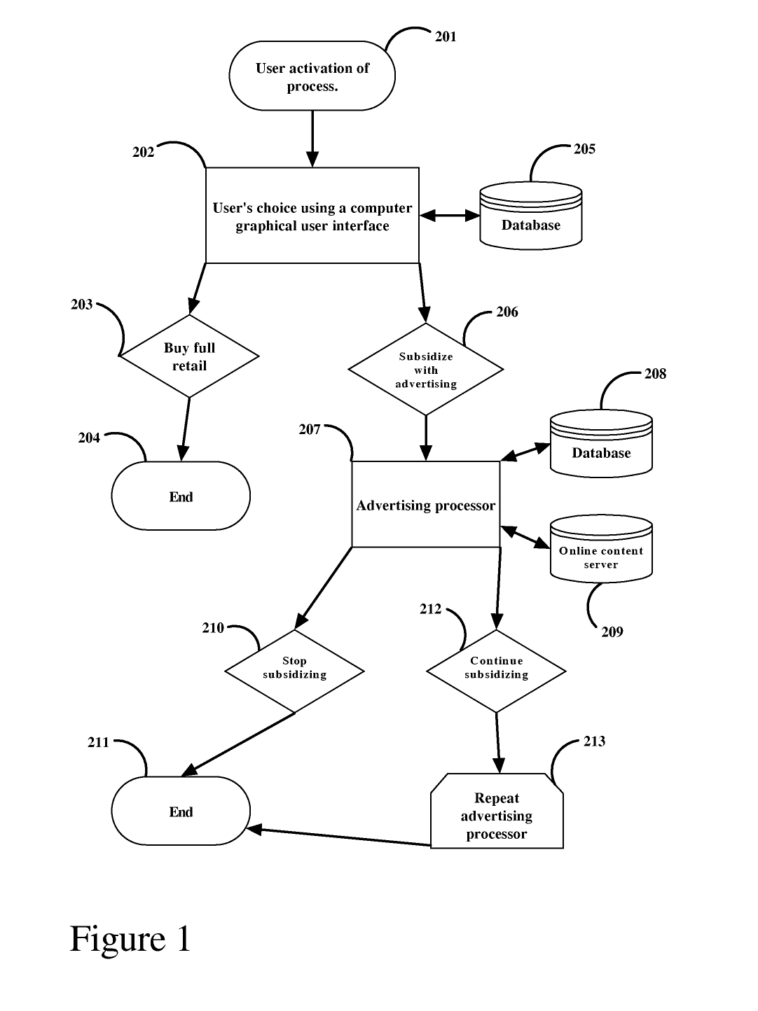

(1) FIG. 1 is a pictorial flow chart which explains the process of this system of price subsidiary using prepaid sponsor messages;

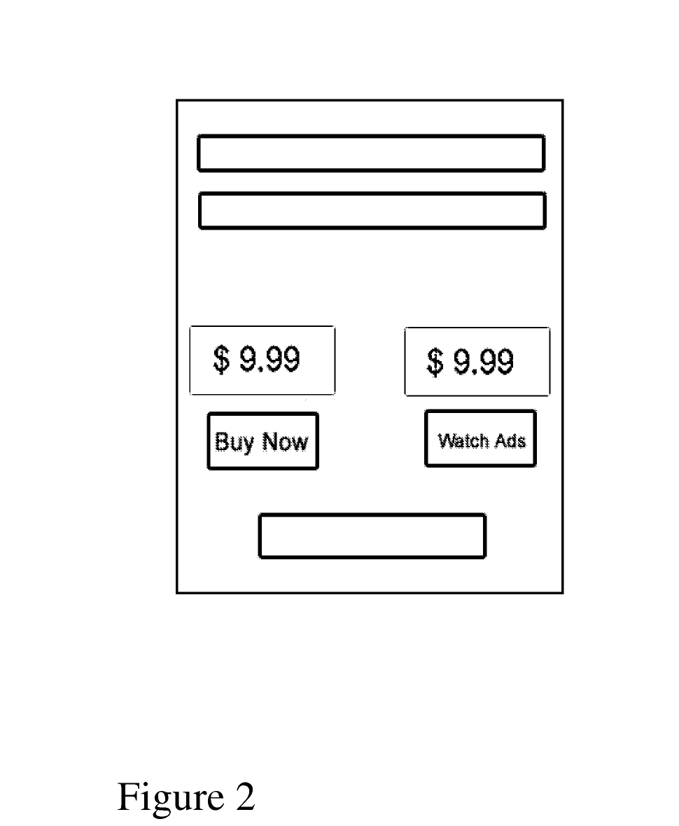

(2) FIG. 2 is an example of a graphical user interface provided by the facilitator which offers products from content owners and offers multiple payment options to the consumer at the point of sale ; and

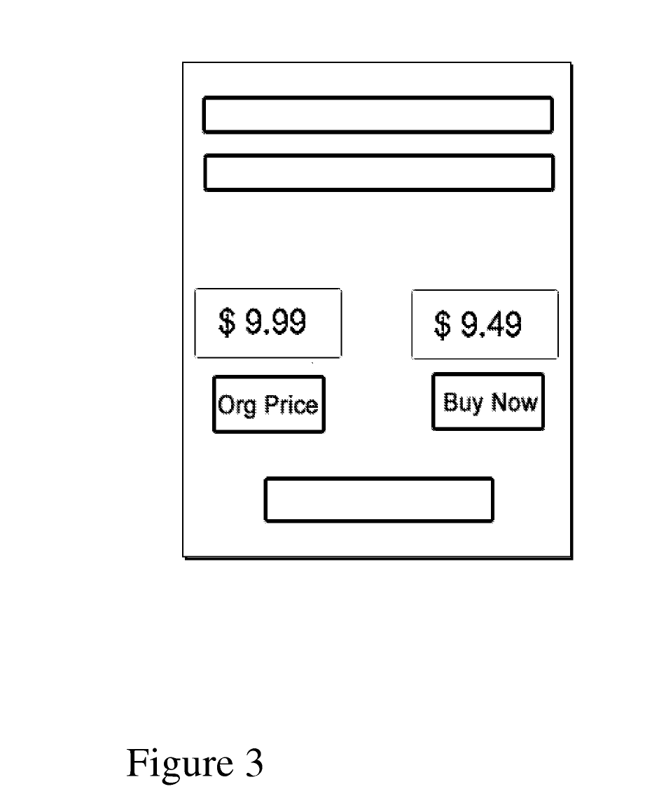

(3) FIG. 3 is the example of the graphical user interface explained in FIG. 2 after the consumer has viewed a sponsor message and received a price reduction to the retail price.

### DESCRIPTION OF THE PREFERRED EMBODIMENT

FIG. 1 represents the process of an optional progressive price reduction system using sponsorship subsidization execution between the consumer, the facilitator, the content owner, and the sponsor as taught by this invention:
(1) 201 is the start of the process in which the consumer select the product for consumption using the facilitators graphical user interface;
(2) 202 represent the graphical user interface provided by the facilitator which is operated online with databases or offline using memory mechanisms;
(3) 203 represents the action taken by the consumer with the graphical user interface to pay for the desired product at the content owner's full retail price without exposure to sponsor messages;
(4) 204 represents a successful payment transaction logged by the graphical user interface and consumer receipt of the product of interest;
(5) 205 represents the database used to store metadata and digital products supplied by content owners for distribution through the facilitator's graphical user interface;
(6) 206 represents the action taken by the consumer with the graphical user interface to view sponsor messages to reduce the product's current price through subsidization;
(7) 207 represents the embedded or external multimedia extension of the facilitator's graphical user interface used to take instruction and serve sponsor messages to the consumer;
(8) 208 represents a database used to record impressions made of the sponsor messages conducted through the facilitator's graphical user interface;
(9) 209 represents a internet capable or local server used to deliver multimedia files from the sponsor delivered to the consumer through the facilitator's graphical user interface;
(10) 210 represent the choice made by the consumer to stop the subsidizing process once started and paying the current reduced price of the product of interest;
(11) 211 represents a successful transaction logged by the graphical user interface and consumer receipt of the product of interest;
(12) 212 represents the consumer's decision to continue subsidizing the product price using sponsor messages;
(13) 213 represent the graphical user interface process started at figure example number 207;

FIG. 2 is a single image which represents an example of the sponsor message delivering component of the facilitator's graphical user interface. The price of $9.99 on the left side of the image represents the full retail price which the consumer can pay for immediately. The price of $9.99 on the right side of the image represents the adjustable field where the retail price can be reduced by sponsor subsidization.

FIG. 3 is a single image which represents an example of the sponsor message delivering component of the facilitator's graphical user interface of FIG. 2 after a successful sponsored message impression offering a subsidy of $0.50.

What is claimed is:

1. An optional progressive price reduction system using sponsorship subsidization which gives consumers multiple payment options comprising of an option to pay the full retail price of a product and an option to watch prepaid sponsor messages to reduce the retail price of the product.

2. The optional progressive price reduction system using sponsorship subsidization of claim 1, wherein the product is provided by a content owner through a facilitator.

3. The optional progressive price reduction system using sponsorship subsidization of claim 1, wherein sponsor messages is multimedia content comprising:
text messages;
static pictures;
video;
audio;
flash;
and printable material.

4. The optional progressive price reduction system using sponsorship subsidization of claim 1, wherein the sponsor message is delivered to consumers through a graphical user interface.

5. The optional progressive price reduction system using sponsorship subsidization of claim 4, wherein the graphical user interface is operated and managed by a facilitator.

6. The optional progressive price reduction system using sponsorship subsidization of claim 5, wherein the facilitator can also be the sponsor or the content owner.

7. The optional progressive price reduction system using sponsorship subsidization of claim 1, wherein the sponsor message is prepaid and money is imported and dispersed through a facilitator to content owners from escrow.

8. The optional progressive price reduction system using sponsorship subsidization of claim 1, wherein the prepaid value of the sponsor message is used to reduce the current retail price of the product according to the prepaid message impression value.

9. The optional progressive price reduction system using sponsorship subsidization of claim 7, wherein the facilitator share a percentage of the sponsor message impression value with the content owner.

10. The optional progressive price reduction system using sponsorship subsidization of claim 1, wherein the preferred price can be any variation of reduction below the original price including subsidy for the full value of the product's retail price.

11. The optional progressive price reduction system using sponsorship subsidization of claim 5, wherein the graphical user interface is provided by the facilitator for consumers to make decisions to purchase the product at the current price or continue the price reduction process using additional sponsor messages.
